(19) United States
(12) Patent Application Publication
(10) Pub. No.: US 2025/0088117 A1
(43) Pub. Date: Mar. 13, 2025

(54) BATTERY PACK WITH TRIPLE-ACTIVE BRIDGE DC-DC CONVERTER

(71) Applicant: Our Next Energy, Inc., Novi, MI (US)

(72) Inventor: Ashish Kumar, Santa Clara, CA (US)

(73) Assignee: Our Next Energy, Inc., Novi, MI (US)

(21) Appl. No.: 18/826,527

(22) Filed: Sep. 6, 2024

Related U.S. Application Data
(60) Provisional application No. 63/581,276, filed on Sep. 7, 2023.

(51) Int. Cl. H02M 3/335; H01M 10/42; H01M 50/51; H02J 7/34; H02M 3/00; H02M 3/28

(52) U.S. Cl. CPC H02M 3/33576; H01M 10/4264; H01M 50/51; H02M 3/01; H02M 3/285; H02M 3/33573; H02J 7/342; H02J 2207/20

(57) ABSTRACT

A highly efficient arrangement for a battery pack including a first battery and a second battery inductively coupled together to transfer energy from the second battery to the first battery includes a triple-active bridge DC-DC converter.

### RELATED APPLICATIONS

This application claims priority to U.S. Provisional Application No. 63/581,276 filed on Sep. 7, 2023, and is herein incorporated by reference in its entirety.

### FIELD OF THE DISCLOSURE

This disclosure relates to a battery pack, such as for electric vehicles (EVs), employing a traction battery coupled with a range-extender battery through a DC-DC converter, and more particularly to such battery packs in which the range-extender battery supplements the power from the traction battery as needed.

### BACKGROUND OF THE DISCLOSURE

It is known to utilize triple-active bridge DC-DC converters to integrate renewable energy sources with energy storage systems to provide a steady power supply to a DC bus. Triple-active bridge DC-DC converters have also been proposed for use in simultaneously charging and discharging both a low-voltage battery and a high-voltage battery. Triple-active bridge DC-DC converters have also been used for converting a three-phase AC input into a high-voltage DC output. The literature also describes use of a triple-active bridge operated to induce sinusoidal current perturbations in first and second batteries in order to evaluate the state of charge and state of health.

The inventor of the battery packs disclosed herein has filed a patent application for a battery pack coupling a traction battery with a lower voltage range-extender battery through a dual-active bridge DC-DC converter as shown in FIG. 1. Battery pack 100 includes a first active bridge 102 and a second active bridge 104 that are inductively coupled together through a transformer 106. Connected in parallel with first active bridge 102 is range-extender battery 108 and connected in parallel with second active bridge 104 is traction battery 110 (which typically has a higher voltage than battery 108). Battery pack 100 includes a plurality of switching units 112, 113, 114, 115, 116, 117, 118, 119 that convert DC from battery 108 to AC at transformer 106 and convert AC from transformer 106 back to DC at battery 110. The battery-pack 100 also includes inductor 120 and capacitors 122, 124. A plurality of battery packs 100 can be arranged in series, as shown in FIG. 2 to provide a desired voltage across terminals 126, 128. The range-extender batteries 108 supplement power from the traction batteries 110 as they become depleted, such as to provide extended range for an EV. A problem with the arrangement of FIG. 1 is that the efficiency of the transfer of power from the batteries 108 drops as the difference between the voltage of traction battery 110 and range-extender battery 108 increases. This is illustrated in FIG. 3 which is a plot of modeled and measured efficiency as a function of traction battery voltage when the range-extender voltage is 36 volts. For example, when the traction battery voltage is within about 5 volts of the range-extender battery, the efficiency of power transfer is about 95% or higher. However, when the voltage difference is greater than about 10 volts, the efficiency starts to drop (e.g., less than 93%). It is believed that the inefficiency that occurs at higher voltage differences between the voltages of the batteries 108 and 110 is attributable to the relatively large fluctuations in the inductor current (i.e., current at the transformer) over time, and a large phase shift between the inverter voltage (i.e., voltage across the primary side of the DAC) and the rectifier voltage (i.e., voltage across the secondary side of the DAC), as illustrated in FIG. 4.

### SUMMARY OF THE DISCLOSURE

The battery pack disclosed herein provides a new application for triple-active bridge (TAB) DC-DC converters which improves the efficiency of power transfer from a range-extender battery to a traction battery (or more generally from a first battery to a second battery).

The battery packs described herein include a first battery; a second battery having a lower voltage than the first battery; and a TAB DC-DC converter arranged to split the output from the first battery between two bridges on a first side of a transformer to efficiently supplement power to the second battery on a second side of the transformer.

Also disclosed is a process for operating the TAB DC-DC as a DAB converter equivalent to further improve overall efficiency when the voltages of the first and second batteries are more nearly identical.

### BRIEF DESCRIPTION OF THE DRAWINGS

FIG. 1 is a schematic representation of a dual-active bridge inductively coupling a traction battery and a range-extender battery.

FIG. 2 is a schematic representation of a plurality of arrangements as shown in FIG. 1 electrically connected in series.

FIG. 3 is a graph showing energy transfer efficiency of a dual-active bridge inductively coupling a traction battery with a range-extender battery.

FIG. 4 is a graphical illustration of transformer current, traction battery voltage and range-extender battery voltage as a function of time for the arrangement shown in FIG. 1.

FIG. 5 is a schematic representation of a triple-active bridge inductively coupling a traction battery with a range-extender battery.

FIG. 6 is a graphical illustration of transformer current, traction battery voltage and range-extender battery voltage as a function of time for the triple bridge arrangement shown in FIG. 5.

FIG. 7 is a graph showing energy transfer losses as a function of traction battery voltage for a range-extender battery having a voltage of 36 volts.

FIG. 8 is a graph representing an advantage of operating the triple-active bridge DC-DC converter as either a DAB or a TAB converter, depending on traction battery voltage.

FIG. 9 is a schematic representation of a plurality of TAB DC-DC converters with batteries arranged in series.

FIG. 10 is a drawing showing symmetrical flux for the conventional transformer shown in FIG. 1.

FIG. 11 is a drawing showing asymmetrical flux of the transformer shown in FIG. 5.

FIG. 12 is a drawing showing a TAB DC-DC converter having an asymmetrical transformer in which the primary side of the TAB employs one full-bridge and one half-bridge.

FIG. 13 is a drawing showing a TAB DC-DC converter having an asymmetrical transformer in which the primary side of the TAB employs one full-bridge and one quarter-bridge.

FIG. 14 is a drawing showing a TAB DC-DC converter having an asymmetrical transformer in which the primary side of the TAB employs one half-bridge and one quarter-bridge.

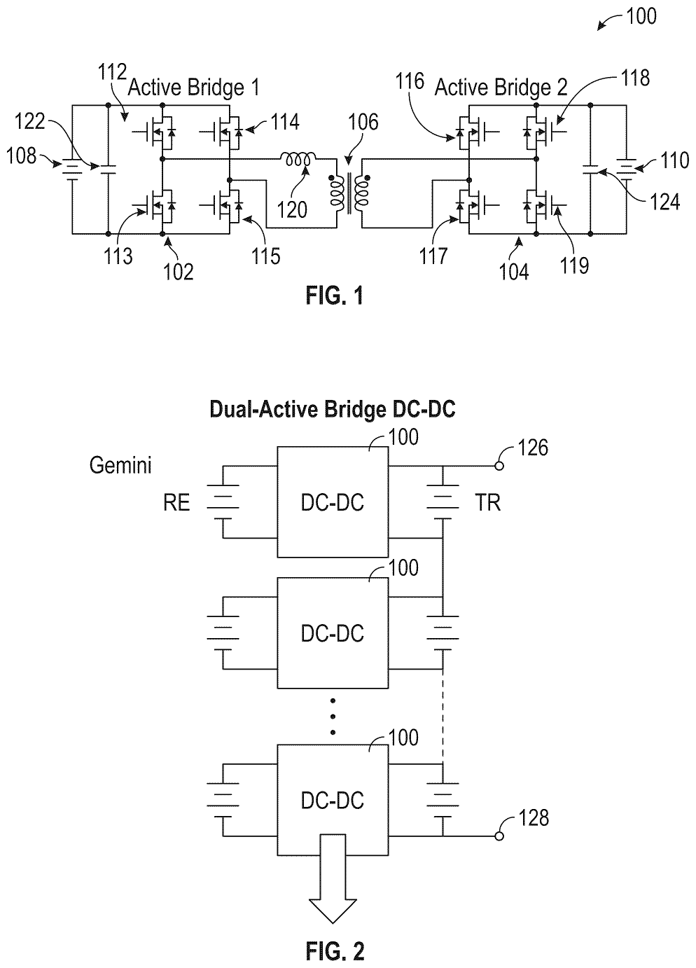

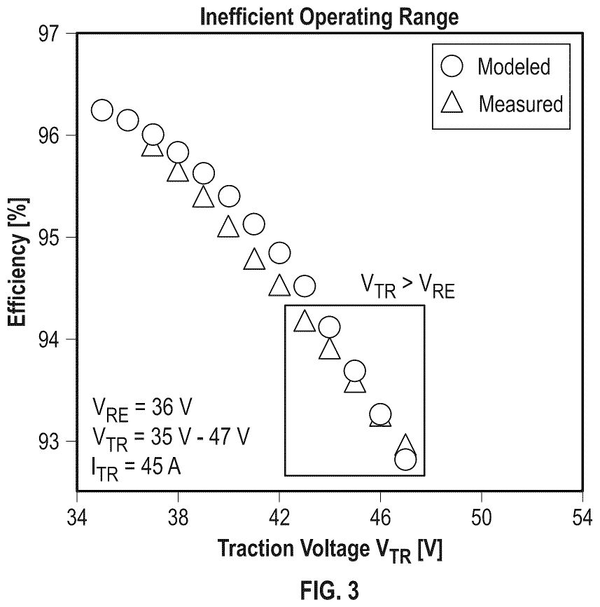

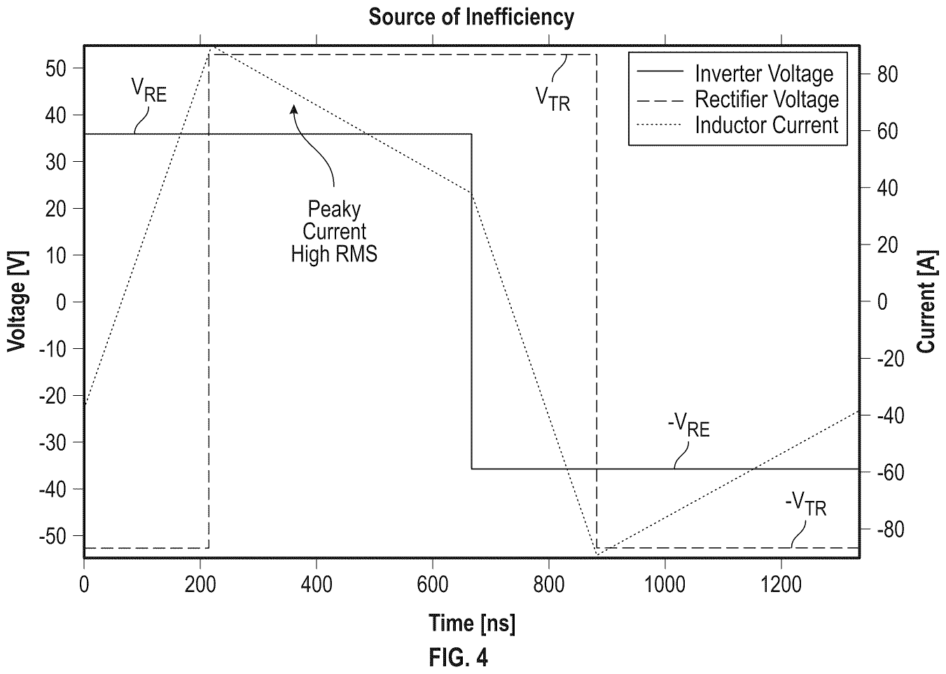

### DETAILED DESCRIPTION

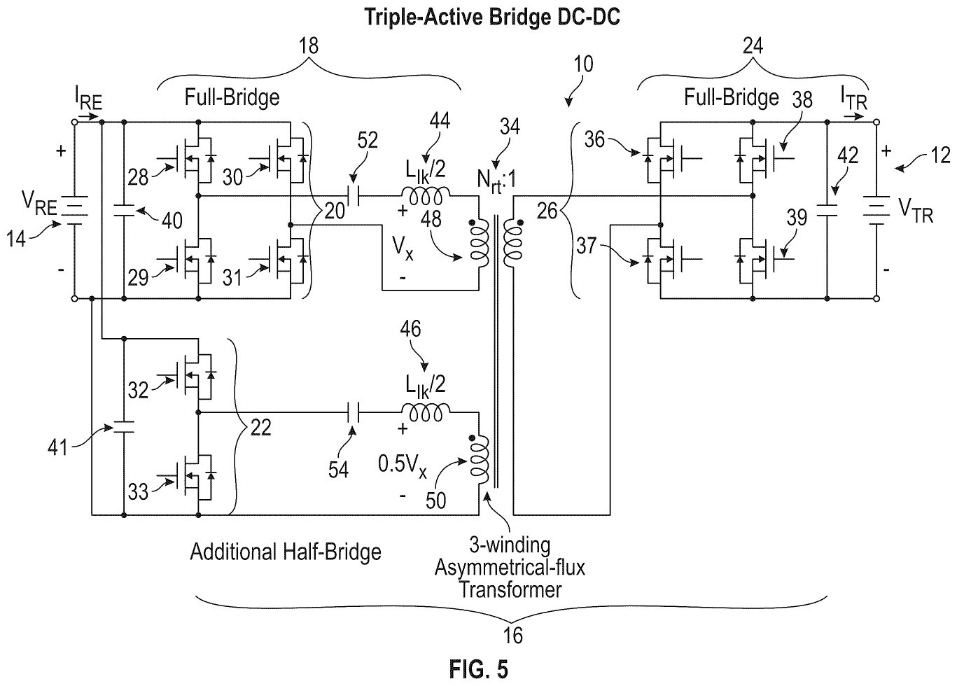

Shown in FIG. 5 is a battery pack 10 comprising a second battery 12 (e.g., traction battery), a first battery 14 (e.g., range-extender battery), and a triple-active bridge (TAB) DC-DC converter 16 comprising a primary side 18 including a full bridge 20 and a half-bridge 22, and a secondary side 24 having a single full bridge 26. Battery 14 is electrically connected to full bridge 20 and half-bridge 22. By appropriate switching of switching units 28, 29, 30, 31, 32 and 33, DC from battery 14 is converted to an AC that is inductively coupled to the secondary side 24 through transformer 34. The AC induced on secondary side 24 is converted back to DC by appropriate switching of switching units 36, 37, 38, 39.

A “bridge” as used herein refers to a circuit comprising a plurality of switches arranged and operated to transform an electrical current from a DC source into an AC current. The full bridges described herein include four switches arranged and operated to output an AC voltage whose peak value is equal to the DC input voltage (minus typically negligible losses). A half-bridge circuit can include two switches arranged and operated to output an AC voltage whose peak value is about half of the DC input voltage, and a quarter-bridge is a circuit that can include four switches arranged and operated to output an AC voltage whose peak value is about one-quarter (25%) of the DC input voltage. The term “fractional bridge” as used herein refers to a circuit comprising switches arranged and operated to output an AC voltage whose peak value is a fraction of the DC input voltage.

Battery pack 10 also includes capacitor 40 arranged in parallel with battery 14 and full bridge 20, capacitor 41 arranged in parallel with battery 14 and half-bridge 22, capacitor 42 arranged in parallel with battery 12 and full bridge 26, and inductors 44 and 46 arranged in series with transformer inductors 48 and 50, respectively. Additionally, capacitor 52 is arranged in series with inductors 44 and 48, and capacitor 54 is arranged in series with inductors 46, 50.

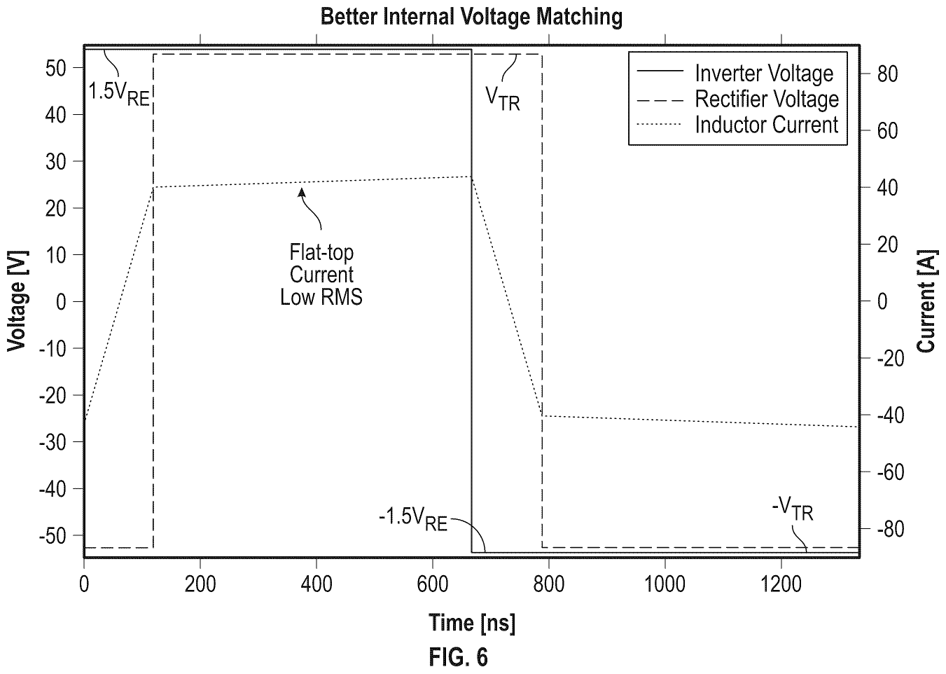

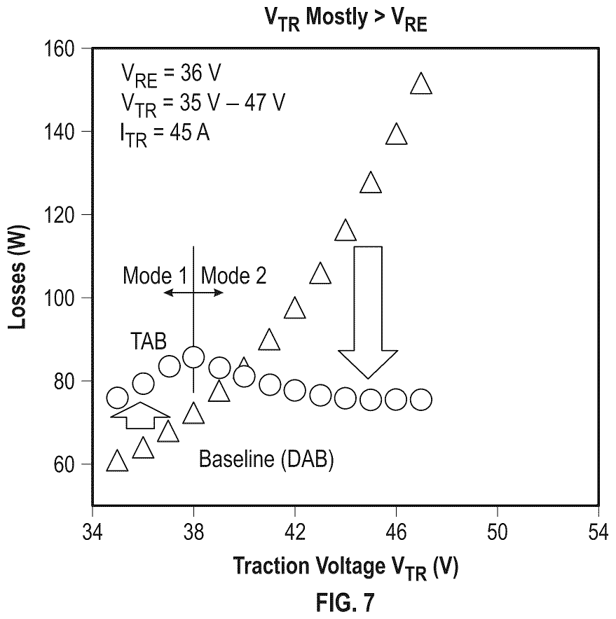

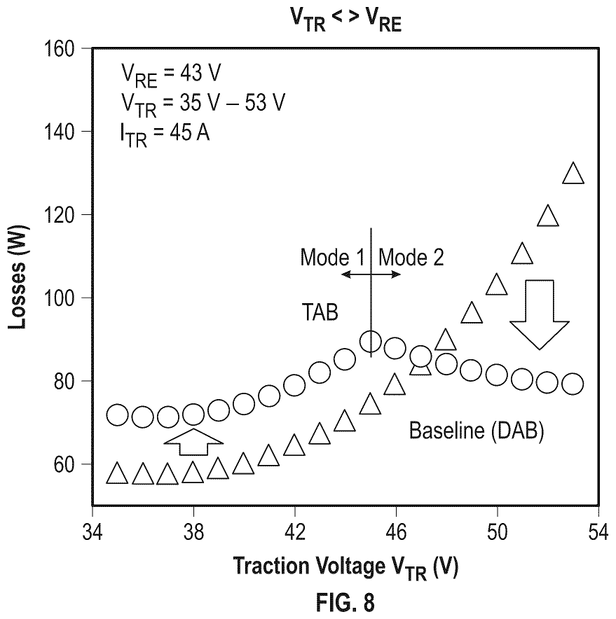

TAB DC-DC converter 16 provides better internal voltage matching and flatter peak currents, as shown in FIG. 6 resulting in improved power transfer efficiency, as compared with a DAB converter, when the voltage difference between the first and second batteries are higher (e.g., greater than about 5 volts when the lower-voltage traction battery has a voltage of about 36 volts). This improvement is represented in FIG. 7 which shows power losses (Watts) as a function of traction battery voltage when the range-extender voltage is 36 volts. The TAB configuration provides reduced losses (and higher efficiencies) when the traction battery voltage is greater than about 40 volts. Similarly, FIG. 8 shows power losses (Watts) as a function of traction battery voltage when the range-extender voltage is 43 volts. In this example, the TAB configuration provides reduced losses (and higher efficiencies) when the traction battery voltage is greater than about 47 volts.

As shown in FIG. 6, the DAB configuration is more efficient than the TAB configuration when the differences between the traction and range-extender batteries (AV) are lower. An advantage of the TAB configuration is that it can be operated to simulate and reproduce the efficiency advantage of the DAB configuration at lower AV by setting switching unit 30 to off (open) and setting switching unit 31 to on (closed), while switching units 28, 29, 32 and 33 continue high frequency switching to produce an AC output to transformer 34. For example, in the case of the 36 volt range-extender battery, switching units 30 and 31 would be set to remain OFF and ON, respectively when the traction battery voltage is below about 38 volts.

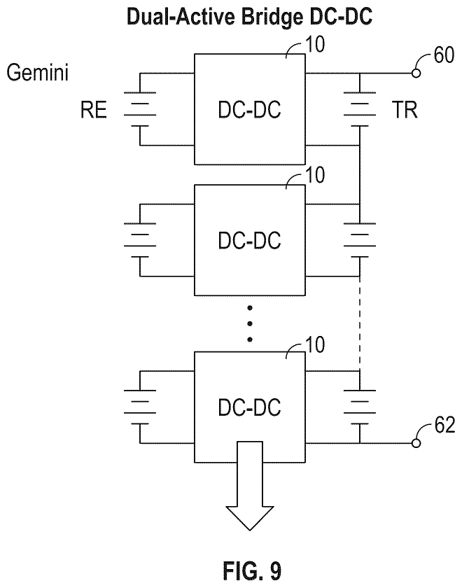

A plurality of battery packs 10 can be arranged in series, as shown in FIG. 9, to provide a desired voltage across terminals 60, 62.

The term “battery” as used herein can include any number of cells arranged in any combination of serial and/or parallel arrangement to provide a positive terminal and a negative terminal.

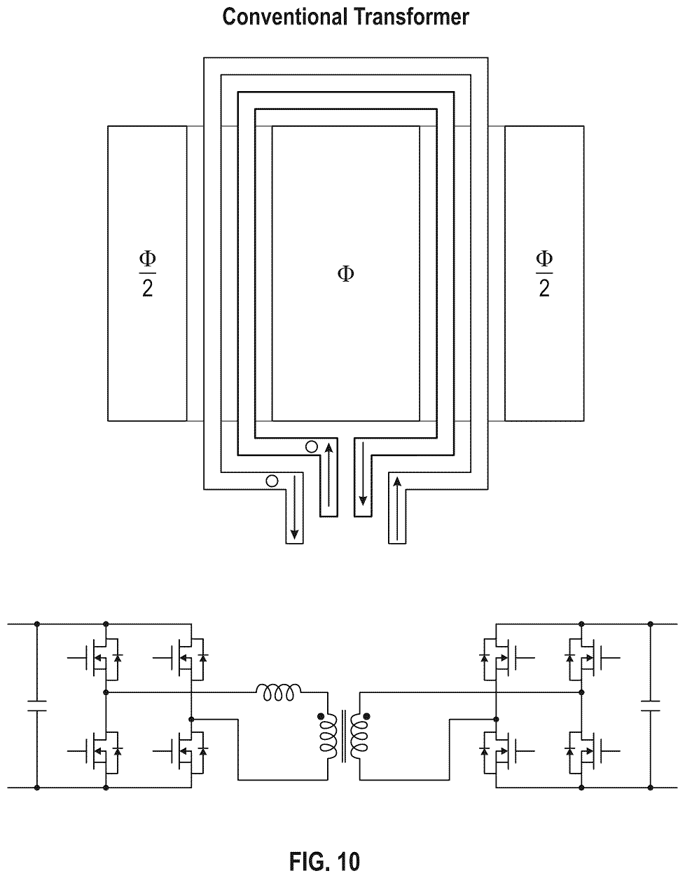

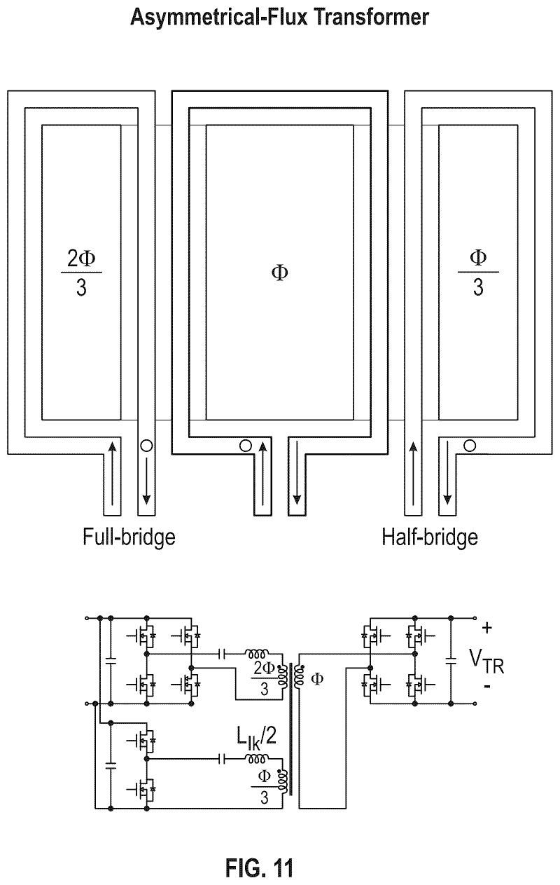

FIGS. 10 and 11 show a schematic comparison of a conventional transformer (of FIG. 1) and an asymmetrical-flux transformer (of FIG. 5), wherein two-thirds of the total magnetic flux on the primary side of the transformer is induced by the full bridge and one-third is induced by the half-bridge.

The described triple-active bridge DC-DC converters can be regarded as having asymmetrical flux transformers in the sense that the magnetomotive force (MMF) contributions from the first bridge on the primary side and the second bridge on the primary side are different, meaning their respective contributions to the magnetic flux through a magnetic core (e.g., consisting of a ferromagnetic material, such as iron) of the transformer are different. The MMF contribution for each of the transformer windings associated with each bridge on the primary side is equal to the product of the number of turns in the winding and the electrical current through the winding, which in turn is approximately proportional to the contribution of each bridge to the magnetic flux. When the number of turns of each winding on the primary side of the transformer is equal, the contribution of each bridge on the primary side of the transformer is proportional to the voltage output from the bridge.

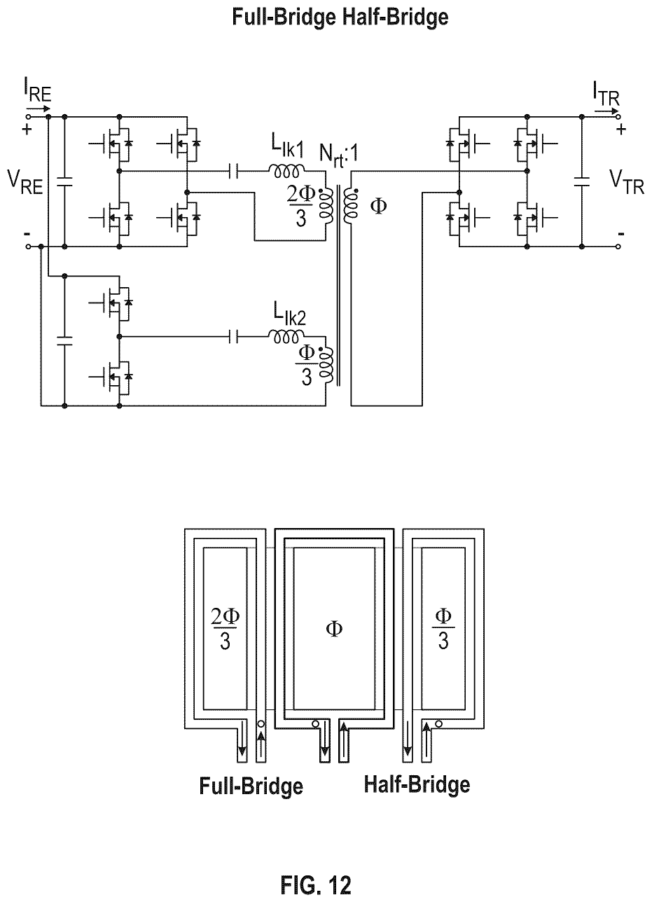

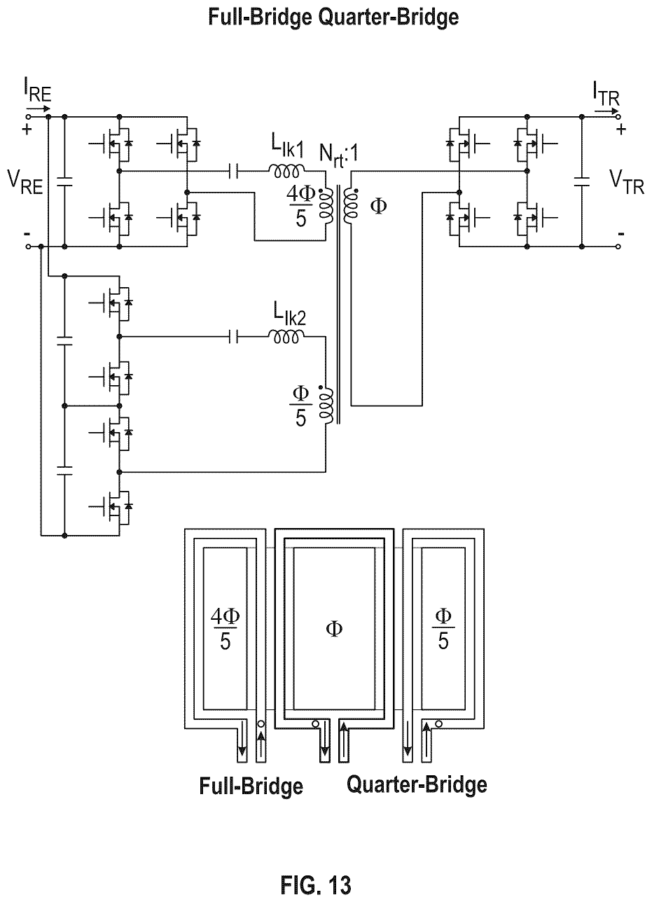

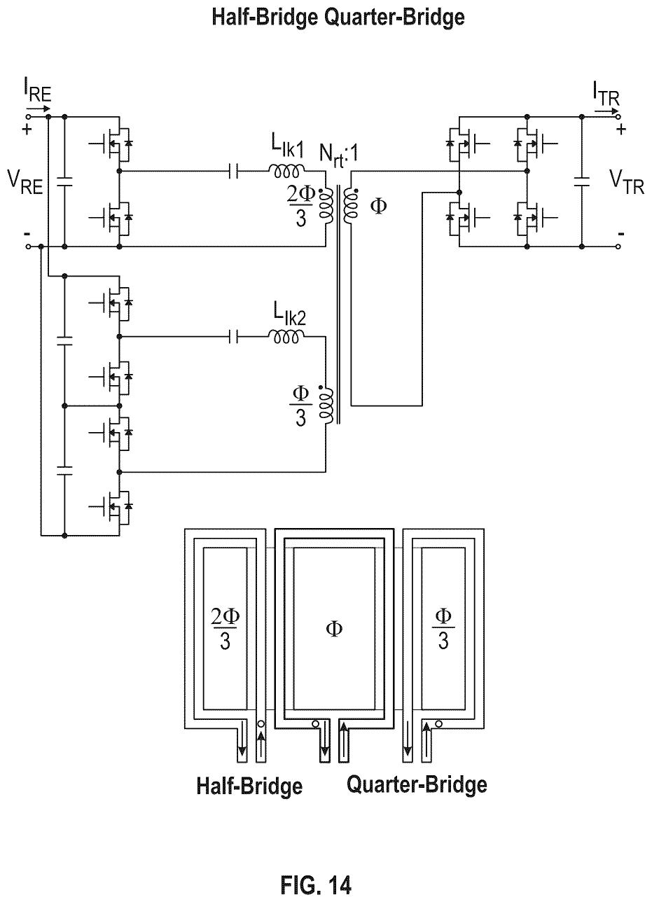

FIGS. 12-14 illustrate examples of various bridge structures having an asymmetrical-flux transformer. FIG. 12 shows an example in which the first bridge on the primary side is a full bridge and the second bridge on the primary side is a half-bridge, wherein the full bridge contributes two-thirds (⅔) of the total MMF and magnetic flux, and the half-bridge contributes one-third (⅓) of the total MMF and magnetic flux through the magnetic circuit generally defined by a magnetic core of the transformer. FIG. 13 shows an example in which the first bridge on the primary side is a full bridge contributing four-fifths (⅘) of the total magnetic flux through the magnetic core of the transformer, and the second bridge is a quarter-bridge contributing one-fifth (⅕) of the total magnetic flux through the magnetic core. FIG. 14 shows an example in which the first bridge is a half-bridge contributing two-thirds (⅔) of the total magnetic flux through the core of the transformer and the second bridge is a quarter-bridge contributing one-third (⅓) of the total magnetic flux through the core.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

1. A battery pack comprising:
a triple-active bridge DC-DC converter having a transformer, first and second bridges on a first side of the transformer, and a full-bridge on a second side of the transformer, wherein at least one of the two bridges is a fractional bridge;
a first battery electrically connected in parallel with each of the first and second bridges on the first side of the transformer; and
a second battery electrically connected with the full-bridge on the second side of the transformer.

2. The battery pack of claim 1, wherein each bridge on the primary side of the triple-active bridge includes a capacitor and an inductor in series with a transformer inductive winding.

3. An energy storage system comprising a plurality of battery packs of claim 2 arranged in series.

4. The battery pack of claim 1, wherein the magnetic flux at a magnetic core of the transformer is asymmetric.

5. The battery pack of claim 4, wherein two-thirds of the total magnetic flux on the first side of the bridge is induced by the first bridge on the first side of the transformer and one-third is induced by the second bridge on the first side of the transformer.

6. A process for operating the triple-active bridge DC-DC converter of claim 2 as a double-active bridge DC-DC converter, comprising maintaining switching elements in the full bridge in selected static states such that the full bridge effectively functions as a half-bridge.

7. The battery pack of claim 1, wherein the first bridge on the first side of the transformer is a full-bridge and the second bridge on the first side of the transformer is a half-bridge.

8. The battery pack of claim 1, wherein the first bridge on the first side of the transformer is a full-bridge and the second bridge on the first side of the transformer is a quarter-bridge.

9. The battery pack of claim 1, wherein the first bridge on the first side of the transformer is a half-bridge and the second bridge on the first side of the transformer is a quarter-bridge.

10. A battery pack comprising:
a triple-active bridge DC-DC converter having a transformer, the transformer including a magnetic core, a first winding on a first side of the transformer having a predetermined number of turns, wound around one leg of the core and a second winding on the first side of the transformer having the same number of turns wound around a second leg of the core, a first bridge for inverting a DC input to produce an AC output electrically connected with the first winding, a second bridge for inverting the DC input to produce an AC output electrically connected with the second winding, and a third winding on a second side of the transformer electrically connected to an input side of a third bridge for rectifying an AC current to provide a DC output; and
a battery having an output electrically connected to an input of each of the first and second bridges on the first side of the transformer.

11. The battery pack of claim 10, wherein each bridge on the primary side of the triple-active bridge includes a capacitor and an inductor in series with a transformer inductive winding.

12. An energy storage system comprising a plurality of battery packs of claim 10 arranged in series.

13. The battery pack of claim 10, wherein the first bridge on the first side of the transformer is a full-bridge and the second bridge on the first side of the transformer is a half-bridge.

14. The battery pack of claim 10, wherein the first bridge on the first side of the transformer is a full-bridge and the second bridge on the first side of the transformer is a quarter-bridge.

15. The battery pack of claim 10, wherein the first bridge on the first side of the transformer is a half-bridge and the second bridge on the first side of the transformer is a quarter-bridge.
